(19) United States
(12) Patent Application Publication
(10) Pub. No.: US 2026/0236400 A1
(43) Pub. Date: Aug. 13, 2026

(54) OPERATION METHOD AND APPARATUS FOR INPUT METHOD PROGRAM, AND ELECTRONIC DEVICE AND STORAGE MEDIUM

(71) Applicant: Beijing Zitiao Network Technology Co., Ltd., Beijing (CN)

(72) Inventor: Haobo LIU, Beijing (CN)

(21) Appl. No.: 19/471,330

(22) PCT Filed: Apr. 16, 2024
(86) PCT No.: PCT/CN2024/088042

§ 371 Date: Sep. 30, 2025

(30) Foreign Application Priority Data
Apr. 23, 2023 (CN) 202310441490.8

(51) Int. Cl. G06F 12/1009; G06F 9/54; G06F 12/0866

(52) U.S. Cl. CPC G06F 12/1009; G06F 9/545; G06F 12/0866

(57) ABSTRACT

Provided in the embodiments of the present disclosure are an operation method and apparatus for an input method program, and an electronic device and a storage medium. The method includes: before executing an input function of an input method program, acquiring a virtual address corresponding to lexicon data which is required to execute the input function; loading the lexicon data into a kernel space corresponding to the virtual address; and in response to a user instruction, calling target lexicon data in the kernel space, so as to execute the input function, which corresponds to the user instruction, in the input method program.

### CROSS-REFERENCE TO RELATED APPLICATIONS

This application is based on and claims the benefit of priority to the Chinese patent application No. 202310441490.8 filed on Apr. 23, 2023, which is hereby incorporated by reference in its entirety into the present application.

### TECHNICAL FIELD

Embodiments of the present disclosure relate to the technical field of computers, and in particular to a method and apparatus for running an input method program, an electronic device and a storage medium.

### BACKGROUND

An input method program is one of common programs for human-computer interaction and information exchange between users, and in order to improve input efficiency, existing input method programs are generally provided with numerous lexicon (i.e., word stock or word library) data, and an input function such as spelling, word formation, error correction or the like can be realized by using word information provided by the lexicon data.

### SUMMARY

The embodiments of the present disclosure provide a method and apparatus for running an input method program, an electronic device and a storage medium.

In a first aspect, an embodiment of the present disclosure provides a method for running an input method program, comprising:
acquiring a virtual address corresponding to lexicon data required for executing an input function of the input method program before executing the input function; loading the lexicon data into a kernel space corresponding to the virtual address; and calling target lexicon data in the kernel space in response to a user instruction to execute an input function corresponding to the user instruction in the input method program.

In a second aspect, an embodiment of the present disclosure provides an apparatus for running an input method program, comprising:
an acquiring module configured to acquire a virtual address corresponding to lexicon data required for executing an input function of the input method program before executing the input function;
a loading module configured to load the lexicon data into a kernel space corresponding to the virtual address; and
a calling module configured to call target lexicon data in the kernel space in response to a user instruction to execute an input function corresponding to the user instruction in the input method program.

In a third aspect, an embodiment of the present disclosure provides an electronic device, comprising:
a processor, and a memory communicatively coupled to the processor; wherein
the memory stores computer-executable instructions; and
the processor executes the computer-executable instructions stored by the memory to implement the method for running an input method program as described in the first aspect and various possible designs of the first aspect.

In a fourth aspect, an embodiment of the present disclosure provides a computer-readable storage medium having stored thereon computer-executable instructions which, when executed by a processor, implement the method for running an input method program as described in the first aspect and various possible designs of the first aspect.

In a fifth aspect, an embodiment of the present disclosure provides a computer program product comprising a computer program which, when executed by a processor, implements the method for running an input method program as described in the first aspect and various possible designs of the first aspect.

According to the method and apparatus for running an input method program, the electronic device and the storage medium provided by embodiments of the present disclosure, a virtual address corresponding to lexicon data required for executing an input function of the input method program is acquired before executing the input function; the lexicon data is loaded into a kernel space corresponding to the virtual address; and target lexicon data in the kernel space is called in response to a user instruction to execute an input function corresponding to the user instruction in the input method program.

### BRIEF DESCRIPTION OF THE DRAWINGS

In order to more clearly illustrate the embodiments of the present disclosure or technical solutions in related arts, the drawings used in the description of the embodiments or related arts will be briefly described below, and it is apparent that the drawings in the description below are some embodiments of the present disclosure, and for those skilled in the art, other drawings can be obtained according to the drawings without creative efforts.

FIG. 1 is a schematic diagram of an execution process of an input method program according to an embodiment of the present disclosure;

FIG. 2 is a first schematic flow diagram of a method for running an input method program according to an embodiment of the present disclosure;

FIG. 3 is a flow diagram of a specific implementation of step S101 in the embodiment shown in FIG. 2;

FIG. 4 is a schematic diagram of a process of acquiring a virtual address of lexicon data according to an embodiment of the present disclosure;

FIG. 5 is a flow diagram illustrating a specific implementation of step S102 in the embodiment shown in FIG. 2;

FIG. 6 is a schematic diagram of a process for executing an input function according to an embodiment of the present disclosure;

FIG. 7 is a second schematic flow diagram of a method for running an input method program according to an embodiment of the present disclosure;

FIG. 8 is a flow diagram of a specific implementation of step S202 in the embodiment shown in FIG. 7;

FIG. 9 is a schematic diagram of a process for determining missing data according to an embodiment of the present disclosure;

FIG. 10 is a flow diagram illustrating a specific implementation of step S204 in the embodiment shown in FIG. 7;

FIG. 11 is a block structural diagram of an apparatus for running an input method program according to an embodiment of the present disclosure;

FIG. 12 is a schematic structural diagram of an electronic device according to an embodiment of the present disclosure;

FIG. 13 is a schematic hardware structural diagram of an electronic device according to an embodiment of the present disclosure.

### DETAILED DESCRIPTION

To make the objectives, technical solutions and advantages of the embodiments of the present disclosure more apparent, the technical solutions in the embodiments of the present disclosure will be described clearly and completely with reference to the drawings in the embodiments of the present disclosure, and it is apparent that the described embodiments are some, but not all embodiments of the present disclosure. All other embodiments, which can be derived by a person skilled in the art from the embodiments disclosed herein without creative efforts, are intended to be within the scope of the present disclosure.

It should be noted that, user information (including but not limited to user device information, user personal information, etc.) and data (including but not limited to data for analysis, stored data, presented data, etc.) involved in the present disclosure are information and data authorized by the user or fully authorized by each party, and the collection, use and processing of the related data need to comply with relevant laws and regulations and standards in relevant countries and regions, and are provided with corresponding operation entries for the user to select authorization or denial.

An application scenario for the embodiments of the present disclosure is explained as follows.

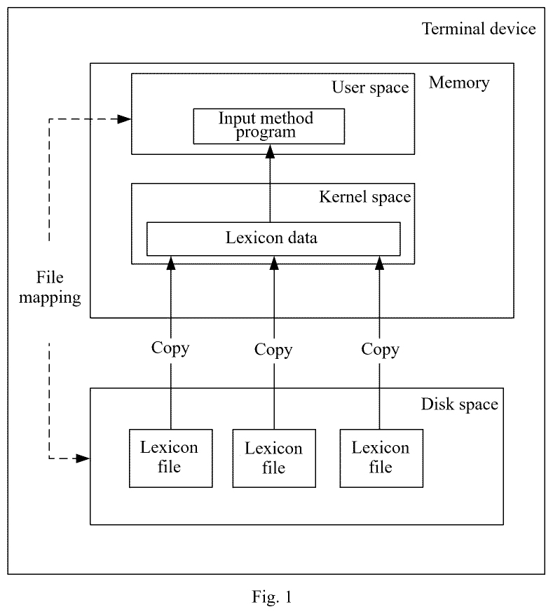

The method for running an input method program according to the embodiments of the present disclosure can be applied to a scenario where the input method program is called for information input. Specifically, the method according to the embodiments of the present disclosure may be applied to a terminal device; FIG. 1 is a schematic diagram of an execution process of an input method program according to the embodiments of the present disclosure; as shown in FIG. 1, lexicon files of the input method program are stored in a disk space (hard disk) of the terminal device, after the input method program is started, the terminal device copies lexicon data in the lexicon files in the disk into a kernel space in a memory, and then establishes a mapping relation between a user space and the disk space, and when the lexicon data is required for executing an input function of the input method program, the lexicon data corresponding to the lexicon files is obtained from the kernel space through a page table, that is, the lexicon data is loaded in a file mapping manner. Thereafter, in response to a user instruction, the execution of the input function is completed by using the lexicon data, such as the input function of spelling, word formation, error correction, or the like of the input method program.

In the related art, with respect to the above technical solution for loading the lexicon data in the file mapping manner, after the lexicon data is copied into the kernel space, the characteristic of data cache can be realized by using the kernel space, and the lexicon data can be quickly called; on the other hand, however, since the kernel space is shared by all processes, when the input method program is in a background idle state, the operating system will recycle resources of the kernel space, resulting in the removal of the lexicon data stored in the kernel space (physical memory). When the input method program is scheduled again to execute the input function, the input method program (a corresponding thread) accesses the lexicon data on a physical page through the mapped virtual address, and at the moment, because the lexicon data is lacked on the corresponding physical page accessed by the virtual address, a memory management unit of the Central Processing Unit (CPU) issues an interrupt instruction, namely, a page missing interrupt occurs. When page missing interrupt occurs, the operating system needs to re-read the lexicon file from the disk to obtain the lexicon data, and re-copy the lexicon data to the kernel space, and then execute the subsequent input function based on the lexicon data in the kernel space; and, the process results in an increase of the time consumption for calling the lexicon data, and further influences the run smoothness and stability of the input method program. The embodiment of the present disclosure provides a method for running an input method program to solve the above problem.

The lexicon data usually needs to be pre-loaded into the memory for the input method program to call, however, the lexicon data loaded into the memory in the related art will be emptied by the operating system under the condition of insufficient memory resources, which results in the increase of the time consumption for calling the lexicon, and further affects the run smoothness and stability of the input method program.

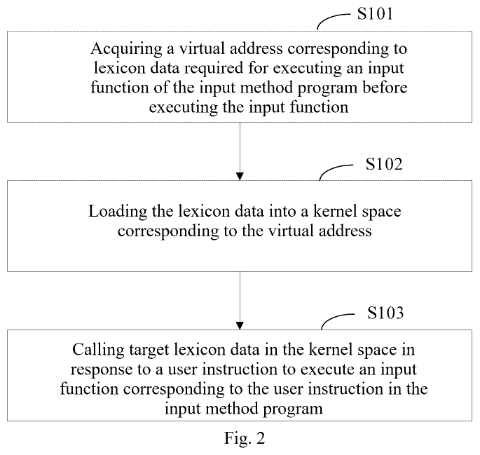

Refer to FIG. 2, which is a first schematic flow diagram of a method for running an input method program according to an embodiment of the present disclosure. The method of the embodiment can be applied to a terminal device, and the method for running an input method program comprises:
step S101: acquiring a virtual address corresponding to lexicon data required for executing an input function of the input method program before executing the input function.

Illustratively, referring to the schematic diagram of the execution process of the input method program shown in FIG. 1, after running the input method program and before executing the input function, a virtual address corresponding to lexicon data is acquired, wherein the virtual address is information representing a data location of the lexicon data, and the input method program acquires the lexicon data through the virtual address and uses the lexicon data to execute the subsequent input function, for example, word formation, error correction, or the like. The virtual address is located in a virtual address space, which is also referred to as a process address space, is a data structure in an operating system kernel, and is an address space formed by a virtual address of a process (for example, an input method program process); the virtual address space and the process address space are technical concepts known to those skilled in the art; the virtual address corresponding to the lexicon data is determined by specific run conditions of the input method program, and the virtual address corresponding to the lexicon data can be obtained by calling a specific virtual address query function, which are related arts known to those skilled in the art, and are not repeated by way of example.

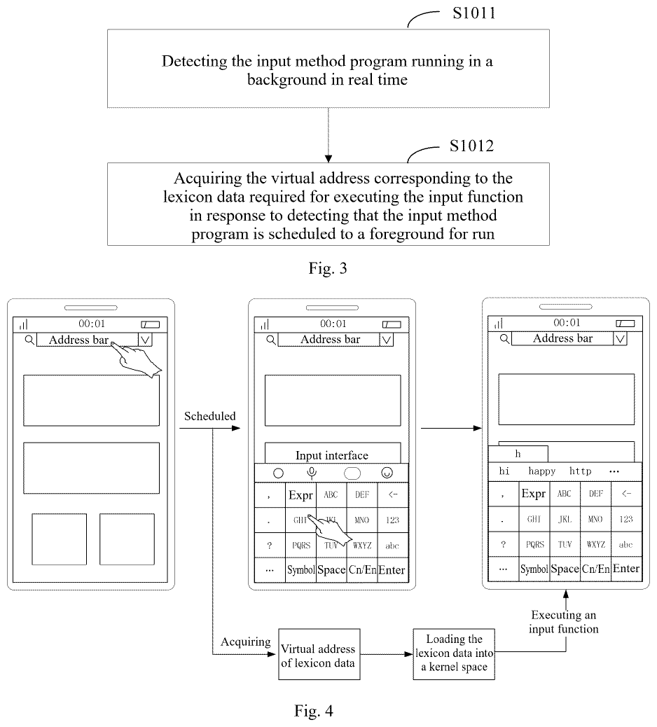

Further, the input function of the input method program refers to a function of the input method program for generating content information such as characters, numbers, identifications, and the like by receiving input information (for example, keyboard information, voice information, etc.) inputted by a user, i.e., a main function of the input method program; the input function is a foreground run function, that is, when the input method function is executed, the input method program needs to be run in a system foreground, i.e., in a scheduled state; in contrast, the input method program may further include non-main functions such as an update function, a push function, and the like, which can be executed in a system background without being scheduled, wherein, unlike the non-main functions such as the update function, the push function, and the like, the achievement of the input function needs to be supported by the lexicon data, and the input method program needs to convert input information inputted by the user into corresponding characters and numbers based on the lexicon data and display them as needed, to realize a basic text input function. Therefore, in a possible implementation, the timing of acquiring the virtual address corresponding to the lexicon data required for executing the input function may be when the input method program is scheduled to the foreground for run. Illustratively, as shown in FIG. 3, a specific implementation of step S101 includes:
step S1011: detecting the input method program running in a background in real time; and
step S1012: acquiring the virtual address corresponding to the lexicon data required for executing the input function in response to detecting that the input method program is scheduled to a foreground for run.

Illustratively, after the input method program is started, in a case where a text input is not conducted, the input method program runs in the system background; and, in a more specific implementation, after the operating system runs, the input method program is started and resides in the system background for run, and, when a text input is required, for example, when a user clicks an edit text field (edit_text) in a webpage or software, the operating system schedules the input method program from the background to the foreground for run, and an input interface of the input method program is displayed. FIG. 4 is a schematic diagram of a process of acquiring a virtual address of the lexicon data according to an embodiment of the present disclosure, and referring to FIG. 4, when a terminal device (for example, a smartphone) runs a browser program, upon receiving a click operation of a user on an address bar, the terminal device schedules an input method program and displays an input interface of the input method program, and at the same time, the terminal device (input method program) acquires the virtual address of the lexicon data after detecting that the input interface is scheduled and displayed, and then loads the lexicon data into a kernel space based on the virtual address of the lexicon data. Then, the user may further input keyboard information by operating the input interface of the input method program, for example, clicking the “GHI” key, and the input method program performs an input function (word formation function) using the lexicon data, to display words including “h” letter, such as “hi”, “happy”, “http”, and the like shown in the figure, in the input method interface. The virtual address of the lexicon data is known preset information after the input method program is started, and the preset virtual address of the lexicon data can be directly read, the specific procedure of which is not repeated.

Step S102: loading the lexicon data into a kernel space corresponding to the virtual address.

Illustratively, after obtaining the virtual address corresponding to the lexicon data, in a possible case, if the lexicon data has already stored in the kernel space, the terminal device may directly obtain the lexicon data based on the virtual address, and then use the lexicon data to complete the input function such as word formation, error correction, or the like. This usually occurs when the input method program is in the foreground for run, and the operating system will not clean and recycle memory data used by an application in a scheduled state, so that the corresponding lexicon data can be directly obtained based on the virtual address. In another possible case, if the lexicon data is not yet stored in the kernel space, the terminal device cannot directly obtain the lexicon data in the kernel space based on the virtual address, and thus will result in page missing interrupt (also referred to as hard page missing interrupt, hard interrupt, hard error). In this base, the terminal device acquires the lexicon data from the disk and loads the lexicon data into the kernel space corresponding to the virtual address, and at the moment, because the input method program does not start executing the input function yet, namely, the lexicon data is not called, it is equivalent that the lexicon data is preloaded, thereby avoiding the problem of page missing interrupt generated when it is required to call the lexicon data to execute the input function in the subsequent steps.

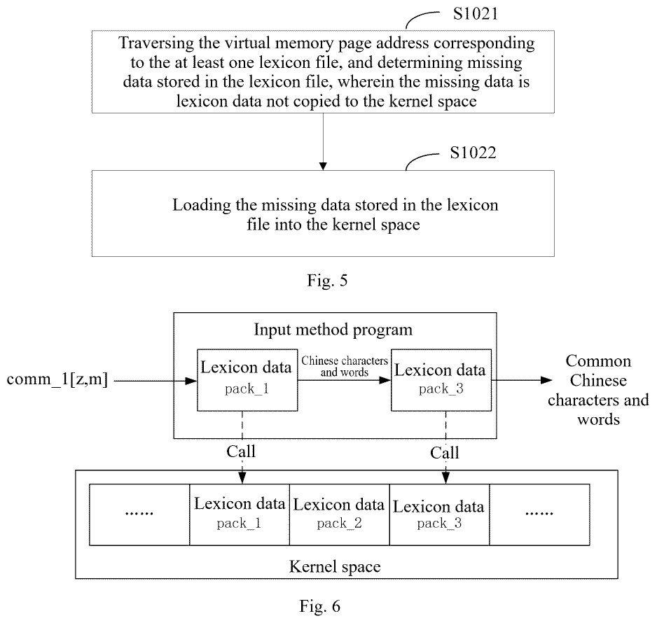

Further, exemplarily, the virtual address includes a virtual memory page address corresponding to at least one lexicon file storing the lexicon data, and the virtual memory page address is one-to-one mapped to a disk address of the lexicon file; as shown in FIG. 5, exemplarily, a specific implementation of step S102 includes:
step S1021: traversing the virtual memory page address corresponding to the at least one lexicon file, and determining missing data stored in the lexicon file, wherein the missing data is lexicon data not copied to the kernel space; and
step S1022: loading the missing data stored in the lexicon file into the kernel space.

Illustratively, the lexicon data required for executing the input function is stored in the disk in the form of a lexicon file, and then based on a mapping relation between a user space and a disk space, the lexicon data required for executing the input function is obtained by the input method program, namely, the lexicon data is loaded in a file mapping manner. The disk address of the lexicon file corresponds to the virtual memory page address; the virtual memory page address refers to an address of a virtual memory page corresponding to the virtual memory, and the virtual memory is a related art that uses a hard disk space as a memory, which are not described herein any more; and the virtual memory page address is information for describing a continuous address position of the virtual memory page; since the virtual memory page is virtualized, the corresponding virtual memory page address is also virtual and is inconsistent with an actual physical memory page address.

Further, under normal conditions (the memory data is not cleaned by the operating system), the lexicon data stored in the lexicon file can be obtained from a corresponding position in the kernel space through the virtual memory page address, therefore, the terminal device can determine whether the corresponding kernel space contains the corresponding lexicon data by traversing the virtual memory page addresses, i.e., sequentially accessing each virtual memory page address and according to access results returned by the operating system, for example, if the access result returned by the operating system is an integer greater than 0 and less than or equal to 127, it is determined that the data stored in the lexicon file corresponding to the virtual memory page address is normal lexicon data; and if the access result returned by the operating system is 0 or Null, it is determined that the data stored in the lexicon file corresponding to the virtual memory page address is missing data. The missing data is lexicon data not copied into the kernel space.

Further, if the data stored in the lexicon file is the missing data, the disk address corresponding to this lexicon file (the virtual memory page address) is acquired based on a preset page table, and the lexicon data is read from the disk address and copied into the kernel space, so that the missing data stored in the lexicon file is loaded into the kernel space. Finally, all the lexicon data required for executing the input function are loaded into the kernel space corresponding to the virtual address, avoiding the subsequent problem of page missing interrupt.

Exemplarily, the method according to the embodiment may be applied to a linux system or an operating system based on the linux system; specifically, when traversing a virtual memory page address corresponding to each lexicon file, the virtual memory page address corresponding to a file page is traversed by using a file readahead mechanism of a linux kernel, so as to load data in at least two consecutive file pages into the kernel space, wherein, the lexicon file is composed of at least two file pages, and each file page is used to store a part of the lexicon data; in this way, due to the advantage that files can be efficiently read ahead by using the file readahead mechanism of the linux kernel, the speed of loading the lexicon data into the kernel space is increased.

Step S103: calling target lexicon data in the kernel space in response to a user instruction to execute an input function corresponding to the user instruction in the input method program.

Exemplarily, after all the lexicon data required for executing the input function are loaded into the kernel space corresponding to the virtual address, in response to a user instruction for triggering the input function, target lexicon data for executing the input function triggered by the user instruction is called from the kernel space, to realize the input function corresponding to the user instruction. The lexicon data can be a functional model containing specific functions, methods and data, and is provided with a corresponding call interface (API) through which the lexicon data is called, to realize lexicon functions of the lexicon data, thereby realizing the corresponding input function according to a set of lexicon functions of one or more lexicon data. FIG. 6 is a schematic diagram of a process for executing an input function according to an embodiment of the present disclosure, and as shown in FIG. 6, exemplarily, user instruction comm_1 includes keyboard information letter “z” and letter “m” (shown as comm_1[z, m]), and is used for instructing the input method program to generate a corresponding phrase based on the keyboard information. The terminal device (input method program) calls lexicon data pack_1 and lexicon data pack_3 in the kernel space as target lexicon data according to the user instruction comm_1, to process the user instruction comm_1, wherein the lexicon data pack_1 is used for forming a word by using the keyboard information as initials to generate Chinese characters and words; the lexicon data pack_3 is used for correcting errors of the Chinese characters and words according to the keyboard information, to obtain common Chinese characters and words. Finally, the common Chinese characters and words are displayed on a display interface of the terminal device, and the executing of the input function is completed.

In the embodiment, before executing an input function of the input method program, a virtual address corresponding to lexicon data required for executing the input function is acquired; the lexicon data is loaded into a kernel space corresponding to the virtual address; and in response to a user instruction, target lexicon data in the kernel space is called, to execute an input function corresponding to the user instruction in the input method program. By acquiring the virtual address before executing the input function of the input method program, and preloading the lexicon data based on the virtual address, when the input function is executed in response to a user instruction, the corresponding target lexicon data can be directly obtained from the kernel space in a file mapping manner, avoiding the problem of hard page missing interrupt caused by memory cleaning, reducing the whole time consumption of calling the lexicon data by the input method program, reducing the jam, and improving the stability and the run smoothness of the input function of the input method program.

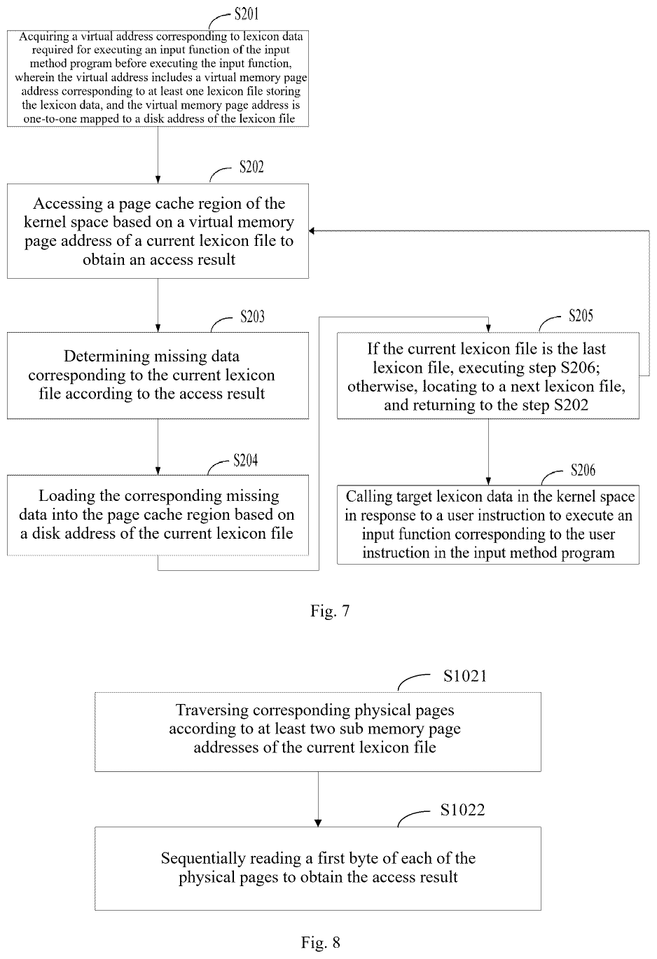

Refer to FIG. 7, which is a second schematic flow diagram of a method for running an input method program according to an embodiment of the present disclosure. In this embodiment, on the basis of the embodiment shown in FIG. 2, the step S102 is further refined, and the method for running an input method program comprises:
step S201: acquiring a virtual address corresponding to lexicon data required for executing an input function of the input method program before executing the input function, wherein the virtual address includes a virtual memory page address corresponding to at least one lexicon file storing the lexicon data, and the virtual memory page address is one-to-one mapped to a disk address of the lexicon file; and
step S202: accessing a page cache region of the kernel space based on a virtual memory page address of a current lexicon file to obtain an access result.

Illustratively, the page cache region is a region in the memory for storing partial disk data, by means of which, the operating system may be allowed to retain some data normally stored on the disk in a kernel region of the memory, so that when the disk is to be accessed, corresponding data can be acquired from the page cache region without reading the data from the disk, thereby increasing data reading and writing speed. In a scenario where the lexicon file used by the input method program is loaded in a file mapping manner, each lexicon file corresponds to a virtual memory page address, which has been described in detail in the embodiment shown in FIG. 2 and is not described herein again. Lexicon files are traversed one-by-one cyclically, to sequentially acquire the virtual memory page address of each lexicon file. Specifically, in a specific cycle, based on the virtual memory page address of the current lexicon file, the address of the page cache region corresponding to the virtual memory page address, that is, the address of the lexicon data corresponding to the virtual memory page address stored in the page cache region, may be obtained, and then the address of the page cache region corresponding to each virtual memory page address is accessed, and the obtained access result is the data at this address.

In a possible implementation, the lexicon file corresponds to at least two physical pages located in the page cache region, and the physical pages are used for storing lexicon data; and the virtual memory page address includes at least two sub memory page addresses, which represent first addresses of the physical pages. As shown in FIG. 8, a specific implementation of the step S202 includes:
step S2021: traversing corresponding physical pages according to at least two sub memory page addresses of the current lexicon file; and
step S2022: sequentially reading a first byte of each of the physical pages to obtain the access result.

Illustratively, the page cache region is formed by physical pages, the virtual memory page address is formed by at least two sub memory page addresses, and the positions of the physical pages are in one-to-one correspondence with the sub memory page addresses, that is, the physical pages are mapped to by means of the sub memory page addresses. In the process of traversing the lexicon files, for each lexicon file, a corresponding physical page is accessed respectively based on a corresponding sub memory page address, a first byte of each physical page is read, and an access result is obtained according to content of the read first byte.

Step S203: determining missing data corresponding to the current lexicon file according to the access result, wherein the missing data is lexicon data not copied to the kernel space.

Illustratively, a specific implementation of the step S203 includes: if a first byte of a first physical page corresponding to the lexicon file is non-preset information, data stored in the first physical page is determined as the missing data.

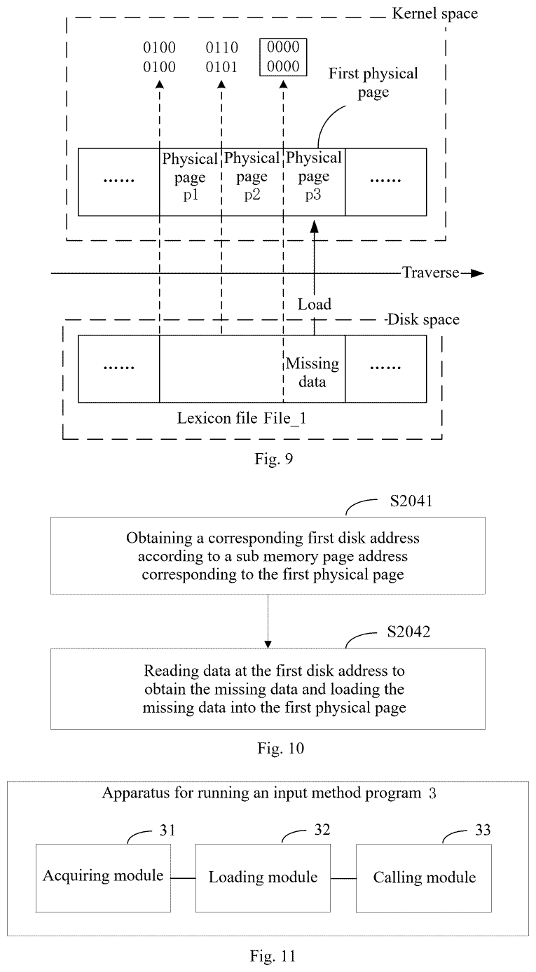

FIG. 9 is a schematic diagram of a process for determining the missing data according to an embodiment of the present disclosure; as shown in FIG. 9, for example, with respect to a process of lexicon file File_1, the lexicon file File_1 corresponds to a plurality of physical pages, such as physical page p1, physical page p2, physical page p3, and the like shown in the figure. The first byte of the physical page p1, the first byte of the physical page p2 and the first byte of the physical page p3 are respectively read according to the sub memory page addresses, to respectively obtain content of the first byte of the physical page p1 as [01000100]; content of the first byte of the physical page p2 as [01100101]; and content of the first byte of the physical page p3 as [00000000]; wherein, [00000000] is non-preset information, and thus, after the first byte of the physical page p3 is read, the physical page p3 is determined as the first physical page, and the data stored in the physical page p3 is determined as the missing data. Then, the lexicon data (missing data) corresponding to the physical page p3 is acquired from the disk space and loaded into the kernel space, to complete the lexicon data required by the input method program.

In this embodiment, by mapping the lexicon file into a plurality of physical pages, and based on the access results to the first bytes of the physical pages, determining whether a corresponding physical page is the missing data, segmented loading and rapid determination of the lexicon data stored in the lexicon file are realized. The speed of determining the missing data is effectively increased, thereby reducing the time consumption for traversing all the lexicon files and improving the loading efficiency of the lexicon data.

Step S204: loading the corresponding missing data into the page cache region based on a disk address of the current lexicon file.

Exemplarily, after the missing data is obtained, the physical page corresponding to the missing data is obtained from the disk and loaded into the kernel space, to complete the lexicon data required by the input method program. As shown in FIG. 10, a specific implementation of the step S204 includes:
step S2041: obtaining a corresponding first disk address according to a sub memory page address corresponding to the first physical page; and
step S2042: reading data at the first disk address to obtain the missing data and loading the missing data into the first physical page.

Illustratively, the first physical page is a physical page storing the missing data; based on the foregoing steps, after determining the first physical page according to the first byte of the physical page, a corresponding first disk address is obtained according to the sub memory page address corresponding to the first physical page, wherein the mapping relation between the memory page address and the disk address is determined by using a preset page table. The lexicon file comprises at least two file pages, the file pages are used for storing lexicon data, and the first disk address is a first address of the file page of the lexicon file. That is, the physical pages in the cache page are in a one-to-one correspondence with the file pages in the disk that constitute the lexicon file. The file page is a result of segmenting the lexicon file, the physical page is a data object after the file page is loaded into the memory, the disk address is an address of the file page, and the first disk address is an address of a first file page corresponding to the first physical page. Therefore, after the first disk address corresponding to the memory page address is obtained, the data at the first disk address, that is, the first file page, is read, and the data held in the first file page, that is, the missing data, is read. Thereafter, actual data in the first file page is loaded into the first physical page in the page cache region, completing the process of loading the missing data into the page cache region.

Step S205: if the current lexicon file is the last lexicon file, executing step S206; otherwise, locating to a next lexicon file, and returning to the step S202.

Further, after the current lexicon file is processed, if the current lexicon file is not the last lexicon file of all lexicon files configured by the input method program, the next lexicon file is continuously located to, and the flow returns to the step S202 to cyclically execute the above steps to process the lexicon file, so that the missing data corresponding to the input function can be loaded into the memory for use; if the lexicon file is the last lexicon file of all the lexicon files configured by the input method program, this shows that all the lexicon files are processed, at the moment, it can be guaranteed that the lexicon data stored in all the lexicon files are all completely loaded into the memory for use; in this case, the problem of page missing interrupt can be avoided, and therefore the cycle can be ended, to execute the subsequent input function calling step.

Step S206: calling target lexicon data in the kernel space in response to a user instruction to execute an input function corresponding to the user instruction in the input method program.

In this embodiment, the steps S201 and S206 are the same as the steps S101 and S103 in the embodiment shown in FIG. 2, and for detailed discussions, reference is made to the embodiment shown in FIG. 2, which is not repeated herein.

FIG. 11 is a block structural diagram of an apparatus for running an input method program according to an embodiment of the present disclosure, which corresponds to the method for running an input method program according to the above embodiment. For ease of illustration, only portions relevant to the embodiment of the present disclosure are shown. Referring to FIG. 11, the apparatus 3 for running an input method program comprises:
an acquiring module 31 configured to acquire a virtual address corresponding to lexicon data required for executing an input function of the input method program before executing the input function;
a loading module 32 configured to load the lexicon data into a kernel space corresponding to the virtual address; and
a calling module 33 configured to call target lexicon data in the kernel space in response to a user instruction to execute an input function corresponding to the user instruction in the input method program.

In an embodiment of the present disclosure, the virtual address includes a virtual memory page address corresponding to at least one lexicon file storing the lexicon data, and the virtual memory page address is one-to-one mapped to a disk address of the lexicon file; the loading module 32 is specifically configured to: traverse the virtual memory page address corresponding to the at least one lexicon file, and load missing data stored in the lexicon file into the kernel space, wherein the missing data is lexicon data not copied to the kernel space.

In an embodiment of the present disclosure, when traversing the virtual memory page address corresponding to the at least one lexicon file and loading missing data stored in the lexicon file into the kernel space, the loading module 32 is specifically configured to: perform, for each lexicon file, the following steps: accessing a page cache region of the kernel space based on a virtual memory page address of a current lexicon file to obtain an access result; determining missing data corresponding to the current lexicon file according to the access result; and loading the corresponding missing data into the page cache region based on a disk address of the current lexicon file.

In an embodiment of the present disclosure, the lexicon file corresponds to at least two physical pages located in the page cache region, the physical pages being used for storing the lexicon data; and the virtual memory page address comprises at least two sub memory page addresses, the sub memory page addresses representing first addresses of the physical pages; when accessing a page cache region of the kernel space based on a virtual memory page address of a current lexicon file to obtain an access result, the loading module 32 is specifically configured to: traverse corresponding physical pages according to at least two sub memory page addresses of the current lexicon file; and sequentially read a first byte of each of the physical pages to obtain the access result.

In an embodiment of the present disclosure, when determining missing data corresponding to the current lexicon file according to the access result, the loading module 32 is specifically configured to: in response to a first byte of a first physical page corresponding to the lexicon file being not preset information, determining data stored in the first physical page as the missing data; the loading module 32 loading the corresponding missing data into the page cache region based on a disk address of the current lexicon file comprises: obtaining a corresponding first disk address according to a sub memory page address corresponding to the first physical page; and reading data at the first disk address to obtain the missing data and loading the missing data into the first physical page.

In an embodiment of the present disclosure, the lexicon file comprises at least two file pages, the file pages being used for storing lexicon data; when traversing the virtual memory page address corresponding to the at least one lexicon file and loading missing data stored in the lexicon file into the kernel space, the loading module 32 is specifically configured to: traverse, for each lexicon file, a virtual memory page address corresponding to the file pages by using a file readahead mechanism of a linux kernel, to load data in at least two consecutive file pages to the kernel space.

In an embodiment of the present disclosure, the acquiring module 31 is specifically configured to: detect the input method program running in a background in real time; and acquire the virtual address corresponding to the lexicon data required for executing the input function in response to detecting that the input method program is scheduled to a foreground for run.

The acquiring module 31, the loading module 32 and the calling module 33 are connected in sequence. The apparatus 3 for running an input method program according to the embodiment may perform the technical solutions of the above method embodiments, and the implementation principle and technical effects thereof are similar, which are not described herein again.

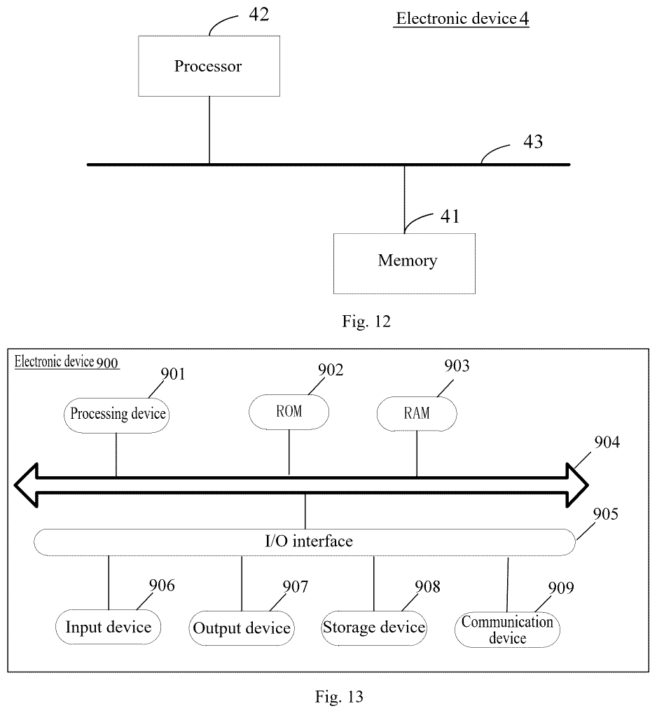

FIG. 12 is a schematic structural diagram of an electronic device according to an embodiment of the present disclosure, and as shown in FIG. 12, the electronic device 7 comprises:
a processor 41, and a memory 42 communicatively coupled to the processor 41; wherein
the memory 42 stores computer-executable instructions;
the processor 41 executes the computer-executable instructions stored in the memory 42 to implement the method for running an input method program in the embodiments shown in FIGS. 2-10.

Optionally, the processor 41 and the memory 42 are connected via a bus 43.

The relevant description may be understood by referring to the relevant description and effects corresponding to the steps in the embodiments corresponding to FIGS. 2-10, and redundant description thereof is not repeated here.

An embodiment of the present disclosure provides a computer-readable storage medium having stored thereon computer-executable instructions which, when executed by a processor, implement the method for running an input method program according to any of the embodiments shown in FIGS. 2-10 of the present disclosure.

An embodiment of the present disclosure provides a computer program product comprising a computer program which, when executed by a processor, implements the method for running an input method program according to the embodiments shown in FIGS. 2-10.

Referring to FIG. 13, a schematic structural diagram of an electronic device 900 suitable for implementing the embodiment of the present disclosure is shown, where the electronic device 900 may be a terminal device or a server. Among them, the terminal device may include, but is not limited to, a mobile terminal such as a mobile phone, a notebook computer, a digital broadcast receiver, a Personal Digital Assistant (PDA), a Portable Android Device (PAD), a Portable Multimedia Player (PMP), a car terminal (e.g., a car navigation terminal), etc., and a fixed terminal such as a digital TV, a desktop computer, etc. The electronic device shown in FIG. 13 is only an example, and should not bring any limitation to the functions and the scope of use of the embodiments of the present disclosure.

As shown in FIG. 13, the electronic device 900 may include a processing device (e.g., central processor, graphics processor, etc.) 901, which may perform various appropriate actions and processes in accordance with programs stored in a Read-Only Memory (ROM) 902 or programs loaded from a storage device 908 into a Random Access Memory (RAM) 903. In the RAM 903, various programs and data necessary for the operation of the electronic device 900 are also stored. The processing device 901, the ROM 902, and the RAM 903 are connected to each other via a bus 904. An input/output (I/O) interface 905 is also connected to the bus 904.

Generally, the following devices may be connected to the I/O interface 905: input device 906 including, for example, a touch screen, touch pad, keyboard, mouse, camera, microphone, accelerometer, gyroscope, or the like; an output device 907 including, for example, a Liquid Crystal Display (LCD), a speaker, a vibrator, and the like; the storage device 908, including, for example, magnetic tape, hard disk, etc.; and a communication device 909. The communication device 909 may allow the electronic device 900 to communicate with other devices, wireless or wired, to exchange data. While FIG. 13 illustrates an electronic device 900 having various devices, it is to be understood that not all illustrated devices are required to be implemented or provided. More or fewer devices may be alternatively implemented or provided.

In particular, the processes described above with reference to the flow charts may be implemented as computer software programs, according to the embodiments of the present disclosure. For example, the embodiments of the present disclosure include a computer program product comprising a computer program carried on a non-transitory computer readable medium, the computer program containing program codes for performing the method illustrated by the flow chart. In such an embodiment, the computer program may be downloaded and installed from a network via the communication device 909, or may be installed from the storage device 908, or may be installed from the ROM 902. The computer program, when executed by the processing device 901, performs the above-described functions defined in the methods of embodiments of the present disclosure.

It should be noted that the computer readable medium of the present disclosure may be a computer readable signal medium or a computer readable storage medium or any combination of the two. The computer readable storage medium may be, for example, but not limited to, an electronic, magnetic, optical, electromagnetic, infrared, or semiconductor system, apparatus, or device, or any combination of the foregoing. More specific examples of the computer readable storage medium may include, but are not limited to: an electrical connection having one or more wires, a portable computer diskette, a hard disk, a Random Access Memory (RAM), a Read-Only Memory (ROM), an Erasable Programmable Read-Only Memory (EPROM-flash Memory) or flash memory), an optical fiber, a portable Compact Disc Read-Only Memory (CD-ROM), an optical storage device, a magnetic storage device, or any suitable combination of the foregoing. In the present disclosure, the computer readable storage medium may be any tangible medium that can contain, or store a program for use by or in connection with an instruction execution system, apparatus, or device. In contrast, in the present disclosure, the computer readable signal medium may include a propagated data signal with computer readable program codes embodied therein, for example, in baseband or as part of a carrier wave. Such a propagated data signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program codes embodied on a computer readable medium may be transmitted using any appropriate medium, including but not limited to: electrical wires, optical cables, RF (Radio Frequency), etc., or any suitable combination of the foregoing.

The computer readable medium may be embodied in the electronic device; or may be separate and not assembled into the electronic device.

The computer readable medium carries one or more programs which, when executed by the electronic device, cause the electronic device to perform the method illustrated in the above embodiments.

Computer program codes for carrying out operations for aspects of the present disclosure may be written in any combination of one or more programming languages, including but not limited to an object oriented programming language such as Java, Smalltalk, C++, including conventional procedural programming languages, such as the “C” language or similar programming languages. The program codes may execute entirely on the user's computer, partly on the user's computer, as a stand-alone software package, partly on the user's computer and partly on a remote computer or entirely on the remote computer or server. In the scenario in which a remote computer is involved, the remote computer may be connected to the user's computer through any type of network, including a Local Area Network (LAN) or a Wide Area Network (WAN), or may be connected to an external computer (for example, through the Internet using an Internet service provider).

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of codes, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in a reverse order, depending upon the functionalities involved. It will also be noted that each block of the block diagrams and/or flowcharts, and combinations of blocks in the block diagrams and/or flowcharts, can be implemented by special purpose hardware-based systems that perform the specified functions or actions, or combinations of special purpose hardware and computer instructions.

The units described in the embodiments of the present disclosure may be implemented by software or hardware. The name of a unit does not in some cases constitute a limitation of the unit itself, for example, a first obtaining unit may also be described as “a unit configured to obtain at least two internet protocol addresses”.

The functions described herein above may be performed, at least in part, by one or more hardware logic components. For example, without limitation, exemplary types of hardware logic components that may be used include: Field-Programmable Gate Arrays (FPGAs), Application-Specific Integrated Circuits (ASICs), Application-Specific Standard products (ASSPs), System On Chip (SOCs), Complex Programmable Logic Devices (CPLDs), and so forth.

In the context of this disclosure, a machine-readable medium may be a tangible medium that can contain, or store a program for use by or in connection with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of the machine-readable storage medium would include an electrical connection based on one or more wires, a portable computer diskette, a hard disk, a Random Access Memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

In a first aspect, according to one or more embodiments of the present disclosure, there is provided a method for running an input method program, comprising:
acquiring a virtual address corresponding to lexicon data required for executing an input function of the input method program before executing the input function; loading the lexicon data into a kernel space corresponding to the virtual address; and calling target lexicon data in the kernel space in response to a user instruction to execute an input function corresponding to the user instruction in the input method program.

According to one or more embodiments of the present disclosure, the virtual address includes a virtual memory page address corresponding to at least one lexicon file storing the lexicon data, and the virtual memory page address is one-to-one mapped to a disk address of the lexicon file; and the loading the lexicon data into a kernel space corresponding to the virtual address comprises: traversing the virtual memory page address corresponding to the at least one lexicon file, and loading missing data stored in the lexicon file into the kernel space, wherein the missing data is lexicon data not copied to the kernel space.

According to one or more embodiments of the present disclosure, the traversing the virtual memory page address corresponding to the at least one lexicon file and loading missing data stored in the lexicon file into the kernel space comprises: performing, for each lexicon file, the following steps: accessing a page cache region of the kernel space based on a virtual memory page address of a current lexicon file to obtain an access result; determining missing data corresponding to the current lexicon file according to the access result; and loading the corresponding missing data into the page cache region based on a disk address of the current lexicon file.

According to one or more embodiments of the present disclosure, the lexicon file corresponds to at least two physical pages located in the page cache region, the physical pages being used for storing the lexicon data; and the virtual memory page address comprises at least two sub memory page addresses, the sub memory page addresses representing first addresses of the physical pages; the accessing a page cache region of the kernel space based on a virtual memory page address of a current lexicon file to obtain an access result comprises: traversing corresponding physical pages according to at least two sub memory page addresses of the current lexicon file; and sequentially reading a first byte of each of the physical pages to obtain the access result.

According to one or more embodiments of the present disclosure, the determining missing data corresponding to the current lexicon file according to the access result comprises in response to a first byte of a first physical page corresponding to the lexicon file being not preset information, determining data stored in the first physical page as the missing data; and the loading the corresponding missing data into the page cache region based on a disk address of the current lexicon file comprises: obtaining a corresponding first disk address according to a sub memory page address corresponding to the first physical page; and reading data at the first disk address to obtain the missing data and loading the missing data into the first physical page.

According to one or more embodiments of the present disclosure, the lexicon file comprises at least two file pages, the file pages being used for storing lexicon data; and the traversing the virtual memory page address corresponding to the at least one lexicon file and loading missing data stored in the lexicon file into the kernel space comprises: traversing, for each lexicon file, a virtual memory page address corresponding to the file pages by using a file readahead mechanism of a linux kernel, to load data in at least two consecutive file pages to the kernel space.

According to one or more embodiments of the present disclosure, the acquiring a virtual address corresponding to lexicon data required for executing an input function of the input method program before executing the input function comprises: detecting the input method program running in a background in real time; and acquiring the virtual address corresponding to the lexicon data required for executing the input function in response to detecting that the input method program is scheduled to a foreground for run.

In a second aspect, according to one or more embodiments of the present disclosure, there is provided an apparatus for running an input method program, comprising:
an acquiring module configured to acquire a virtual address corresponding to lexicon data required for executing an input function of the input method program before executing the input function;
a loading module configured to load the lexicon data into a kernel space corresponding to the virtual address; and
a calling module configured to call target lexicon data in the kernel space in response to a user instruction to execute an input function corresponding to the user instruction in the input method program.

According to one or more embodiments of the present disclosure, the virtual address includes a virtual memory page address corresponding to at least one lexicon file storing the lexicon data, and the virtual memory page address is one-to-one mapped to a disk address of the lexicon file; and the loading module is specifically configured to: traverse the virtual memory page address corresponding to the at least one lexicon file, and load missing data stored in the lexicon file into the kernel space, wherein the missing data is lexicon data not copied to the kernel space.

According to one or more embodiments of the present disclosure, when traversing the virtual memory page address corresponding to the at least one lexicon file and loading missing data stored in the lexicon file into the kernel space, the loading module is specifically configured to: perform, for each lexicon file, the following steps: accessing a page cache region of the kernel space based on a virtual memory page address of a current lexicon file to obtain an access result; determining missing data corresponding to the current lexicon file according to the access result; and loading the corresponding missing data into the page cache region based on a disk address of the current lexicon file.

According to one or more embodiments of the present disclosure, the lexicon file corresponds to at least two physical pages located in the page cache region, the physical pages being used for storing the lexicon data; and the virtual memory page address comprises at least two sub memory page addresses, the sub memory page addresses representing first addresses of the physical pages; when accessing a page cache region of the kernel space based on a virtual memory page address of a current lexicon file to obtain an access result, the loading module 32 is specifically configured to: traverse corresponding physical pages according to at least two sub memory page addresses of the current lexicon file; and sequentially read a first byte of each of the physical pages to obtain the access result.

According to one or more embodiments of the present disclosure, when determining missing data corresponding to the current lexicon file according to the access result, the loading module is specifically configured to: in response to a first byte of a first physical page corresponding to the lexicon file being not preset information, determining data stored in the first physical page as the missing data; the loading module loading the corresponding missing data into the page cache region based on a disk address of the current lexicon file comprises: obtaining a corresponding first disk address according to a sub memory page address corresponding to the first physical page; and reading data at the first disk address to obtain the missing data and loading the missing data into the first physical page.

According to one or more embodiments of the present disclosure, the lexicon file comprises at least two file pages, the file pages being used for storing lexicon data; when traversing the virtual memory page address corresponding to the at least one lexicon file and loading missing data stored in the lexicon file into the kernel space, the loading module is specifically configured to: traverse, for each lexicon file, a virtual memory page address corresponding to the file pages by using a file readahead mechanism of a linux kernel, to load data in at least two consecutive file pages to the kernel space.

According to one or more embodiments of the present disclosure, the acquiring module is specifically configured to: detect the input method program running in a background in real time; and acquire the virtual address corresponding to the lexicon data required for executing the input function in response to detecting that the input method program is scheduled to a foreground for run.

In a third aspect, according to one or more embodiments of the present disclosure, there is provided an electronic device, comprising:
a processor, and a memory communicatively coupled to the processor; wherein
the memory stores computer-executable instructions; and
the processor executes the computer-executable instructions stored by the memory to implement the method for running an input method program as described in the first aspect and various possible designs of the first aspect.

In a fourth aspect, according to one or more embodiments of the present disclosure, there is provided a computer-readable storage medium having stored thereon computer-executable instructions which, when executed by a processor, implement the method for running an input method program as described in the first aspect and various possible designs of the first aspect.

In a fifth aspect, an embodiment of the present disclosure provides a computer program product comprising a computer program which, when executed by a processor, implements the method for running an input method program as described in the first aspect and various possible designs of the first aspect.

The foregoing description is only illustration of the preferred embodiments of the present disclosure and the technical principles employed. It will be appreciated by those skilled in the art that the scope of the present disclosure herein is not limited to a technical solution formed by a particular combination of technical features described above, but also encompasses other technical solutions formed by any combination of features described above or equivalents thereof without departing from the spirit of the present disclosure, for example, technical solutions formed by mutual replacement between the features described above and the technical features disclosed (but not limited to) in the present disclosure and having similar functions.

Further, while operations are depicted in a particular order, this should not be understood as requiring that such operations be performed in the particular order shown or in sequential order. Under certain circumstances, multitasking and parallel processing may be advantageous. Likewise, while several specific implementation details are included in the above discussion, these should not be construed as limitations on the scope of the present disclosure. Certain features that are described in the context of separate embodiments can also be implemented in combination in a single embodiment. Conversely, various features that are described in the context of a single embodiment can also be implemented in multiple embodiments separately or in any suitable sub-combination.

Although the subject matter has been described in language specific to structural features and/or methodological actions, it is to be understood that the subject matter defined in the appended claims is not necessarily limited to the specific features or actions described above. Rather, the specific features and actions described above are merely example forms of implementing the claims.

1. A method for running an input method program, comprising:
acquiring a virtual address corresponding to lexicon data required for executing an input function of the input method program before executing the input function;
loading the lexicon data into a kernel space corresponding to the virtual address; and
calling target lexicon data in the kernel space in response to a user instruction to execute an input function corresponding to the user instruction in the input method program.

2. The method according to claim 1, wherein the virtual address includes a virtual memory page address corresponding to at least one lexicon file storing the lexicon data, and the virtual memory page address is one-to-one mapped to a disk address of the lexicon file; and the loading the lexicon data into a kernel space corresponding to the virtual address comprises:
traversing the virtual memory page address corresponding to the at least one lexicon file, and loading missing data stored in the lexicon file into the kernel space, wherein the missing data is lexicon data not copied to the kernel space.

3. The method according to claim 2, wherein the traversing the virtual memory page address corresponding to the at least one lexicon file and loading missing data stored in the lexicon file into the kernel space comprises:
performing, for each lexicon file, the following steps:
accessing a page cache region of the kernel space based on a virtual memory page address of a current lexicon file to obtain an access result;
determining missing data corresponding to the current lexicon file according to the access result; and
loading the corresponding missing data into the page cache region based on a disk address of the current lexicon file.

4. The method according to claim 3, wherein the lexicon file corresponds to at least two physical pages located in the page cache region, the physical pages being used for storing the lexicon data; and the virtual memory page address comprises at least two sub memory page addresses, the sub memory page addresses representing first addresses of the physical pages;
the accessing a page cache region of the kernel space based on a virtual memory page address of a current lexicon file to obtain an access result comprises:
traversing corresponding physical pages according to at least two sub memory page addresses of the current lexicon file; and
sequentially reading a first byte of each of the physical pages to obtain the access result.

5. The method according to claim 3-or 4, wherein the determining missing data corresponding to the current lexicon file according to the access result comprises:
in response to a first byte of a first physical page corresponding to the lexicon file being not preset information, determining data stored in the first physical page as the missing data; and
the loading the corresponding missing data into the page cache region based on a disk address of the current lexicon file comprises:
obtaining a corresponding first disk address according to a sub memory page address corresponding to the first physical page; and
reading data at the first disk address to obtain the missing data and loading the missing data into the first physical page.

6. The method according to claim 2, wherein the lexicon file comprises at least two file pages, the file pages being used for storing lexicon data; and the traversing the virtual memory page address corresponding to the at least one lexicon file and loading missing data stored in the lexicon file into the kernel space comprises:
traversing, for each lexicon file, a virtual memory page address corresponding to the file pages by using a file readahead mechanism of a linux kernel, to load data in at least two consecutive file pages to the kernel space.

7. The method according to claim 1, wherein the acquiring a virtual address corresponding to lexicon data required for executing an input function of the input method program before executing the input function comprises:
detecting the input method program running in a background in real time; and
acquiring the virtual address corresponding to the lexicon data required for executing the input function in response to detecting that the input method program is scheduled to a foreground for run.

8. (canceled)

9. An electronic device, comprising: a processor, and a memory communicatively coupled to the processor; wherein
the memory stores computer-executable instructions; and
the processor executes the computer-executable instructions stored by the memory to implement the following operations for running an input method program:
acquiring a virtual address corresponding to lexicon data required for executing an input function of the input method program before executing the input function;
loading the lexicon data into a kernel space corresponding to the virtual address; and
calling target lexicon data in the kernel space in response to a user instruction to execute an input function corresponding to the user instruction in the input method program.

10. A non-transitory computer-readable storage medium having stored thereon computer-executable instructions which, when executed by a processor, implement the following operations for running an input method program:
acquiring a virtual address corresponding to lexicon data required for executing an input function of the input method program before executing the input function;
loading the lexicon data into a kernel space corresponding to the virtual address; and
calling target lexicon data in the kernel space in response to a user instruction to execute an input function corresponding to the user instruction in the input method program.

11-12. (canceled)

13. The electronic device according to claim 9, wherein the virtual address includes a virtual memory page address corresponding to at least one lexicon file storing the lexicon data, and the virtual memory page address is one-to-one mapped to a disk address of the lexicon file; and the loading the lexicon data into a kernel space corresponding to the virtual address comprises:
traversing the virtual memory page address corresponding to the at least one lexicon file, and loading missing data stored in the lexicon file into the kernel space, wherein the missing data is lexicon data not copied to the kernel space.

14. The electronic device according to claim 13, wherein the traversing the virtual memory page address corresponding to the at least one lexicon file and loading missing data stored in the lexicon file into the kernel space comprises:
performing, for each lexicon file, the following steps:
accessing a page cache region of the kernel space based on a virtual memory page address of a current lexicon file to obtain an access result;
determining missing data corresponding to the current lexicon file according to the access result; and
loading the corresponding missing data into the page cache region based on a disk address of the current lexicon file.

15. The electronic device according to claim 14, wherein the lexicon file corresponds to at least two physical pages located in the page cache region, the physical pages being used for storing the lexicon data; and the virtual memory page address comprises at least two sub memory page addresses, the sub memory page addresses representing first addresses of the physical pages;
the accessing a page cache region of the kernel space based on a virtual memory page address of a current lexicon file to obtain an access result comprises:
traversing corresponding physical pages according to at least two sub memory page addresses of the current lexicon file; and
sequentially reading a first byte of each of the physical pages to obtain the access result.

16. The electronic device according to claim 14, wherein the determining missing data corresponding to the current lexicon file according to the access result comprises:
in response to a first byte of a first physical page corresponding to the lexicon file being not preset information, determining data stored in the first physical page as the missing data; and
the loading the corresponding missing data into the page cache region based on a disk address of the current lexicon file comprises:
obtaining a corresponding first disk address according to a sub memory page address corresponding to the first physical page; and
reading data at the first disk address to obtain the missing data and loading the missing data into the first physical page.

17. The electronic device according to claim 13, wherein the lexicon file comprises at least two file pages, the file pages being used for storing lexicon data; and the traversing the virtual memory page address corresponding to the at least one lexicon file and loading missing data stored in the lexicon file into the kernel space comprises:
traversing, for each lexicon file, a virtual memory page address corresponding to the file pages by using a file readahead mechanism of a linux kernel, to load data in at least two consecutive file pages to the kernel space.

18. The storage medium according to claim 10, wherein the virtual address includes a virtual memory page address corresponding to at least one lexicon file storing the lexicon data, and the virtual memory page address is one-to-one mapped to a disk address of the lexicon file; and the loading the lexicon data into a kernel space corresponding to the virtual address comprises:
traversing the virtual memory page address corresponding to the at least one lexicon file, and loading missing data stored in the lexicon file into the kernel space, wherein the missing data is lexicon data not copied to the kernel space.

19. The storage medium according to claim 18, wherein the traversing the virtual memory page address corresponding to the at least one lexicon file and loading missing data stored in the lexicon file into the kernel space comprises:
performing, for each lexicon file, the following steps:
accessing a page cache region of the kernel space based on a virtual memory page address of a current lexicon file to obtain an access result;
determining missing data corresponding to the current lexicon file according to the access result; and
loading the corresponding missing data into the page cache region based on a disk address of the current lexicon file.

20. The storage medium according to claim 19, wherein the lexicon file corresponds to at least two physical pages located in the page cache region, the physical pages being used for storing the lexicon data; and the virtual memory page address comprises at least two sub memory page addresses, the sub memory page addresses representing first addresses of the physical pages;
the accessing a page cache region of the kernel space based on a virtual memory page address of a current lexicon file to obtain an access result comprises:
traversing corresponding physical pages according to at least two sub memory page addresses of the current lexicon file; and
sequentially reading a first byte of each of the physical pages to obtain the access result.

21. The storage medium according to claim 19, wherein the determining missing data corresponding to the current lexicon file according to the access result comprises:
in response to a first byte of a first physical page corresponding to the lexicon file being not preset information, determining data stored in the first physical page as the missing data; and
the loading the corresponding missing data into the page cache region based on a disk address of the current lexicon file comprises:
obtaining a corresponding first disk address according to a sub memory page address corresponding to the first physical page; and
reading data at the first disk address to obtain the missing data and loading the missing data into the first physical page.

22. The storage medium according to claim 18, wherein the lexicon file comprises at least two file pages, the file pages being used for storing lexicon data; and the traversing the virtual memory page address corresponding to the at least one lexicon file and loading missing data stored in the lexicon file into the kernel space comprises:
traversing, for each lexicon file, a virtual memory page address corresponding to the file pages by using a file readahead mechanism of a linux kernel, to load data in at least two consecutive file pages to the kernel space.

23. The storage medium according to claim 10, wherein the acquiring a virtual address corresponding to lexicon data required for executing an input function of the input method program before executing the input function comprises:
detecting the input method program running in a background in real time; and
acquiring the virtual address corresponding to the lexicon data required for executing the input function in response to detecting that the input method program is scheduled to a foreground for run.
